(19) United States
(12) Patent Application Publication
(10) Pub. No.: US 2003/0222885 A1
(43) Pub. Date: Dec. 4, 2003

(54) Method of storing color pattern display data and method of processing the same

(76) Inventor: Sadamoto Wakuda, Hamana-gun (JP)

Correspondence Address: CHRISTIE, PARKER & HALE, LLP, P.O.BOX 7068, PASADENA, CA, 91109-7068, US

(21) Appl. No.: 10/436,750

(22) Filed: May 12, 2003

(30) Foreign Application Priority Data
May 30, 2002 (JP) 2002-157878

(51) Int. Cl. G09G 5/02

(52) U.S. Cl. 345/600; 345/589

(57) ABSTRACT

Provided are a method of storing pattern display data and a method of processing the pattern display data, each of which enables storing color pattern display data in a smaller amount of data and using it for displaying the same to thereby decrease the cost of a relevant apparatus.

Regarding the respective color of a color pattern, the data of the color is made the one the format of which is that one pixel consists of one bit. Together with those items of data, color information with respect thereto is kept stored in a ROM 3. The data and color information are read out from the ROM 3 and are processed in a CPU 1 and then are developed into a RAM 4. The data that has thereby been developed, is output to a color display LCD controller 5, 6, directly, or after being converted by using a LUT.

### BACKGROUND OF THE INVENTION

1. Field of the Invention

The present invention relates to a method of storing color pattern display data and a method of processing the same and, more particularly, to a method of storing color pattern display data and a method of processing the same, each of which enables storing color pattern display data, used, for example, in the display of the status of an electronic musical instrument, in a smaller amount of data and enables using that color pattern display data for displaying the same.

2. Description of the Related Art

An electronic musical instrument such as an electronic piano is arranged so that it can have set therein a tone color, tempo, rhythm, demonstration music, etc., and an operation panel thereof is equipped with a display device for displaying the pattern of each of those various set kinds of statuses.

Conventionally, this display device consists of an LCD panel and the pattern is displayed in monochrome. Recently, it has been thought also available that that pattern is displayed in color. In addition, in order that the display may be made easily understandable and easily operable for the user, there is the tendency that the LCD panel is becoming larger in size; and, as a result of many functions' being equipped to the electronic musical instrument, itself, the screen to be displayed is becoming also increased in number.

In a case where a pattern that has been predetermined is displayed in monochrome, not many problems arise in connection with that display. However, in a case where such pattern is displayed in colors, even in a case where the number of colors in which display is made is small as in the case of an electronic musical instrument, etc., the amount of data for use for display increases, raising the problem that for storing it a large amount of space is needed.

For example, in a case where a pattern is displayed in monochrome by using an LCD panel having a pixels number of 320×240, the display only needs the “on” and “off” information of one bit per pixel. Therefore, when storing data for displaying one piece of pattern, it needs only a capacity of 320×240 (=76800) bits.

In contrast to this, in a case where displaying that pattern in colors, that display needs, in every pixel, other than the “on” and “off” information, the information that represents the relevant color. Therefore, if attempting to produce display data in compliance with an LSI, such as an LCD controller, handling the color display data in the data format wherein one pixel is constructed of one byte (=8 bits) and to store that display data as it is, a capacity of 320×240×8 (=614400) bits is needed for displaying one piece of pattern.

### SUMMARY OF THE INVENTION

The present invention has been made in view of the above-described problems and has an object to provide a method of storing pattern display data and a method of processing the same, each of which enables storing color pattern display data in a smaller amount of data and enables using that color pattern display data for displaying the same, particularly, enables reducing the cost of a relevant apparatus performing pattern display in a relatively smaller number of colors.

To attain the above object, in the first aspect of the present invention, it provides a method of storing color pattern display data, the method comprising a step of, regarding respective color of a color pattern, making the data thereof the one having a format of which onepixel consist of a 1 bit, and a step of storing, together with those items of data, color information corresponding to them.

Also, in the second aspect of the present invention, it provides a method of processing color pattern display data, the method comprising a step of sequentially reading out in units of a color, color pattern display data that is stored for every color of the color pattern and that consists of data having a format of which one pixel consisting of 1 bit and color information corresponding to that data, and a step of thereby making the color pattern display data the one having a format capable of being directly input to a display controller to thereby develop it into a RAM.

Also, in the third aspect of the present invention, it provides a method of processing color pattern display data, the method comprising a step of sequentially reading out in units of a color, color pattern display data that is stored for every color of the color pattern and that consists of data having a format of which one pixel consisting of 1 bit and color information corresponding to that data, and a step of thereby making the color pattern display data the one having a format wherein the respective one pixels of the color pattern are expressed by color numbers each indicating the corresponding color, to thereby develop it into a RAM.

Also, in the fourth aspect of the present invention, it provides a method of processing color pattern display data, wherein, in a case where a color pattern to be displayed, or part thereof, is different only in color from the color pattern display data of which has already immediately precedingly been developed, there are directly changed the color numbers representing the pixels of the relevant pattern in the color pattern display data that has already been developed.

Also, in the fifth aspect of the present invention, it provides a method of processing color pattern display data, wherein, in a case where a color pattern to be displayed is different only in part thereof from that the color pattern display data of which has already immediately precedingly been developed, the data and color information regarding that partial color pattern that is different are read out, and, according to the data and color information thereby obtained and the remaining-portion data that is already developed, the color pattern display data is developed into the RAM.

Further, in the sixth aspect of the present invention, it provides a method of processing color pattern display data, wherein the color pattern display data is developed into the RAM in a format of which one pixel consisting of one byte.

According to the first aspect, it is possible to store the color pattern display data in a small amount of data and, especially, to reduce the cost of a relevant apparatus performing pattern display in a relatively small number of colors.

Also, according to the second, third, and sixth aspects, it becomes possible to display by using an existing display controller as it is and, by reading from the RAM the color displaying data developed in the RAM, with a high speed and use that data for displaying the same.

Further, according to the fourth and fifth aspects, since the color pattern is displayed by using the pattern that has already been developed, it is possible to mitigate the burden of processing the data on the side of the CPU and to use the CPU for performing other processing operations by that extent.

### BRIEF DESCRIPTION OF THE DRAWINGS

FIG. 1 is a block diagram illustrating the hardware configuration of an electronic piano to which the present invention is applied;

FIGS. 2A-2D are explanatory views illustrating a method of storing color pattern display data according to the present invention;

FIG. 3 is a view illustrating an example of the color pattern that is to be displayed;

FIG. 4 is a view illustrating the color pattern of FIG. 3 in a format with 256-color bit map data;

FIG. 5 is a view wherein the color pattern of FIG. 3 is expressed according to the present invention;

FIG. 6 is a conceptual view illustrating a method of processing color pattern display data according to the present invention; and

FIG. 7 is a flow chart illustrating an embodiment of the method of processing color pattern display data according to the present invention.

### DETAILEED DESCRIPTION OF THE PREFERRED EMBODIMENT

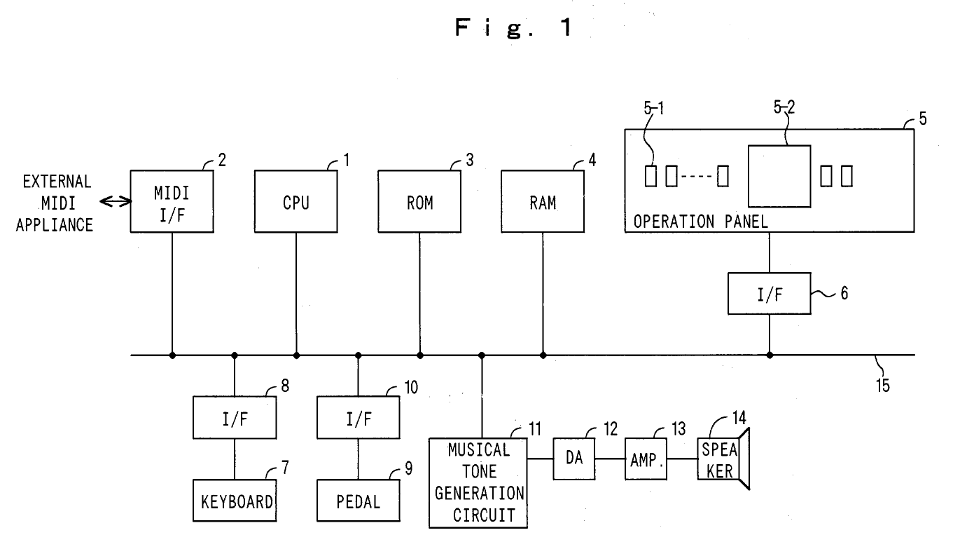

The present invention will hereinafter be explained in detail with reference to the drawings. FIG. 1 is a block diagram illustrating the hardware configuration of an electronic piano to which the present invention is applied. In this figure, a CPU 1 performs control of the entire electronic musical instrument according to the control program stored in a ROM 3. The CPU 1 is equipped, other than a timer interrupt circuit, with a serial port for connection to an MIDI interface (I/F) 2. The MIDI interface 2 is a signal transmission/reception circuit that performs transmission/reception of an MIDI message with respect to an external MIDI appliance.

The ROM 3 stores therein the control program and various kinds of parameters for setting the statuses of the apparatus, such as a plurality of tone color parameters, and, according to the necessity, the parameters regarding the effect. It also stores therein color pattern display data as later described.

A RAM 4 is used as the work area for the CPU 1 and also as a buffer for temporarily storing data of various kinds of registers and is also used for storing therein a color pattern display data that has been read out from the ROM 3 and developed. This RAM 4 may be backed up by, for example, a battery.

An operation panel 5 is equipped with operation members 5-1 for setting various kinds of statuses of the apparatus, a color display 5-2 for displaying the patterns corresponding to the statuses of the apparatus that have been set with use of those operation members, etc. The color display 5-2 is constructed of, for example, an LCD panel.

An operation panel interface (I/F) 6 produces a switch event information that indicates the “on” and “off” of each of the operation members 5-1 of the operation panel 5. This switch event information is stored into the RAM 4 in corresponding relationship to the respective operation member. According to the switch event information, the color pattern display data developed on the RAM 4 is read out and, the status of the apparatus that has been set by the operation member 5-1 is pattern-displayed by the color display 5-2.

A keyboard 7 has a plurality of keys and also has, for example, two sensors that detect the key event information indicating the “on” and “off” of each of the keys and the touch information indicating the key-striking strength, i.e. velocity. A keyboard interface (I/F) 8 produces the key event information and touch information according to the statuses of the relevant sensors. Those items of information are stored into the RAM 4 in corresponding relationship to the key numbers. A pedal 9 and a pedal interface 10 produce pedal event information indicating the “on” and “off” statuses of the pedal operation, and that pedal event information is also stored into the RAM 4.

A musical tone generation circuit 11 is a circuit that generates a desired musical tone signal by the waveform read-out technique. It has, for example, a digital control oscillator (DCO), a digital control filter (DCF), a digital control amplifier (DCA), and an effector. It sequentially reads out waveform data, at address intervals each proportionate to the tone pitch that is to be generated, from a waveform memory having stored therein digital musical-tone waveform sample values. It then performs interpolation calculation and thereby generates a musical tone waveform signal. Also, the musical tone generation circuit 11 has an envelope generation circuit. It multiplies the generated musical-tone waveform signal in the DCA by an envelope signal generated according to the envelope parameter that has been set, to thereby impart the envelope to that musical-tone waveform signal. It then outputs a musical tone signal. The musical tone generation circuit 11 has a plurality of, for example, 32, musical tone generation channels. However, actually, the apparatus is configured such that a plurality of musical tone signals can simultaneously be individually independently generated by time-division multiplexing one piece of musical tone generation circuit.

AD/A converter 12 is a circuit that converts a digital musical tone signal to an analog signal. This analog signal, after being amplified by an amplifier 13, is supplied to a speaker 14, thereby a tone is generated. A bus 15 connects to one another the respective circuits within the electronic musical instrument.

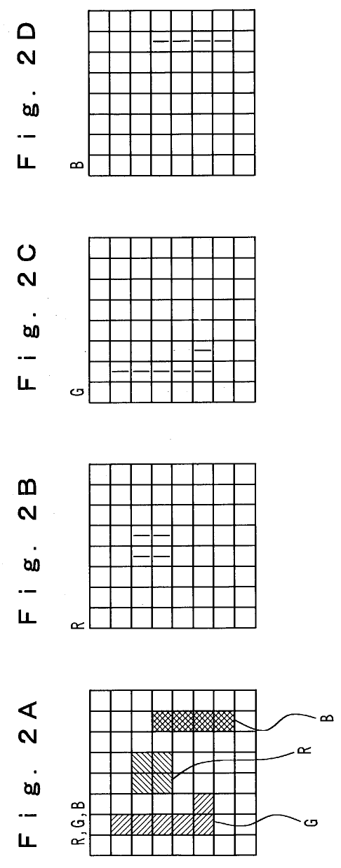

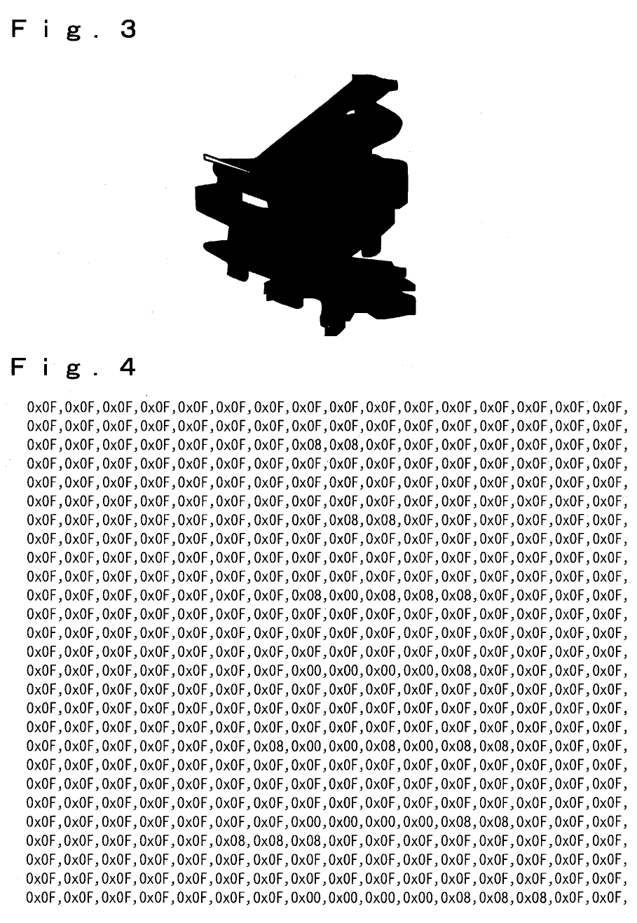

The present invention, by devising the format of the color pattern display data stored in storage means that is, saying by way of the above-described electronic musical instrument, for example, the ROM 3, is intended to decrease the capacity needed for storing that color pattern display data. FIGS. 2A-2D are explanatory views of a method of storing the color pattern display data according to the present invention. For brevity of the explanation, FIGS. 2A-2D illustrate the color pattern by way of three colors of red (R), green (G), and blue (B), and illustrates the examples wherein the sizes thereof are each 8×8 pixels. In an electronic musical instrument, etc., even when referring to a color pattern display, that display can be sufficiently made by using colors the number of which is as small as 3 or so. The present invention aims to perform display of a color pattern the colors number of which is small like that.

In a case where a color pattern to be displayed consists of a combination of R, G, and B patterns as illustrated in, for example, FIG. 2A, the color pattern obtained by extracting only the same-color portion, alone, from that color pattern is as in FIGS. 2B, 2C, and 2D. In the present invention, each of that data is previously stored and it is used as the color pattern display data. The color pattern display data of the respective color has a data format consisting of a 1 bit per pixel that represents “on” and “off” information, wherein the pixel portion that displays that color is “1's” and the pixel portion that does not display that color is “0's”. That color pattern display data is stored into the ROM 3 together with the color information that is to be displayed. In FIGS. 2A-2D, the “0's” corresponding to the pixel portion that does not display the relevant color are omitted.

Assuming that the CPU 1 handles the data by a hexadecimal notation, the “R” displaying data (FIG. 2B) is expressed in the way in which each of the first and second lines is 00H; each of the third and fourth lines is 18H; and each of the fifth, and therefrom-succeeding, lines is 00H. The G-displaying data (FIG. 2C) is expressed in the way in which the first line is 00H; each of the second to fifth lines is 40H; the sixth line is 60H; and each of the seventh, and therefrom-succeeding, lines is 00H. The B-displaying data (FIG. 2D) is expressed in the way in which each of the first to third lines is 00H; each of the fourth to seventh lines is 02H; and the eighth line is 00H.

By storing the color pattern in that format of data, saying by way of the above example, the capacity needed for storage is 8×8 (=64) bits per color and, in all of the three colors, 8×8×3 (=192) bits. That is, the capacity can be greatly reduced compared to the conventional 8×8×8 (=512) bits.

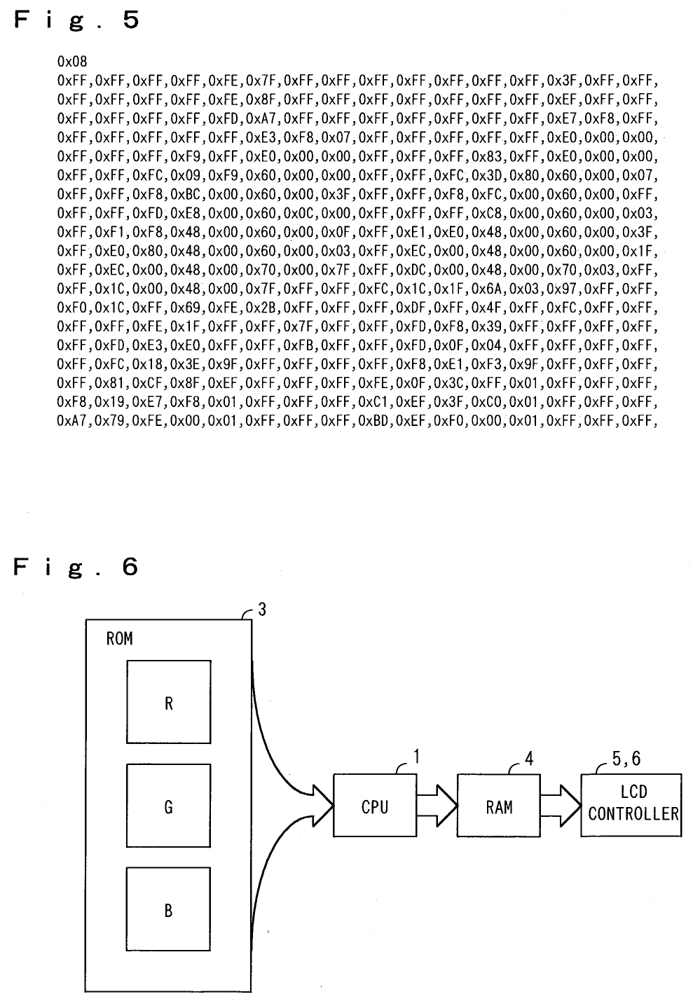

FIGS. 3 to 5 each illustrates a concrete example for storing the color pattern display data. What is illustrated in FIG. 3 is an original color pattern, and the representation of that color pattern in 256-color bit map data is illustrated in FIG. 4. Although for convenience of the illustration the color pattern is shown in monochrome, actually, the color pattern is the pattern consisting of, for example, other than the background color, two colors of red and gray.

This color pattern display data is stored from the left to the right of the lowermost line of the pattern, and, when one-line data finishes being stored, from the left to the right of a line that is one line upper than that line. In this way, the color pattern display data continues to be sequentially stored up to the uppermost line. The data of the respective pixels is 0x0F (0FH), 0x0F, - - - , and one pixel is represented by 8 bits (1 byte), and “00”, “08”, and “0F” are the color numbers representing, for example, red, gray, and background color. Conventionally, the color pattern is stored as that format of data, and that data is read out into the display controller. Therefore, the capacity needed for storage increases. Incidentally, the display controller has a type of construction that can process the data corresponding to the color numbers.

FIG. 5 illustrates an example of a case wherein the color pattern of FIG. 3 is decomposed into every different color according to the present invention; and the pattern of the decomposed gray is constructed using one bit per pixel. In FIG. 5, for example, 0X0F is “00001111”, which represents 8 pixels, in all, with the preceding 4 pixels corresponding to the gray color and the succeeding 4 pixels corresponding to the color that is not gray. Although, in that example, the gray portion is represented by “0” and the non-gray portion is represented by “1”, this can be reversed in the way in which the gray portion is represented by “1” and the non-gray portion is represented by “0”.

Also, in FIG. 5, immediately before the “on/off” information of one bit per pixel, there is added the color information (color number) of 0x08 that indicates the color corresponding to that information. The color pattern thereby indicates that the “on/off” information succeeding thereafter is gray pixel data. Although pixel data of the pattern colored gray has been illustrated, the pixel data of another-colored pattern, obtained by decomposing the color pattern in the above-described way, a red color (color information (color number): 0x00) pattern here in this example, also exists.

In a case where displaying the color pattern according to the data composed in the above-described data format and stored, that color pattern is developed, as, for example, 1-byte per pixel data, onto the RAM by processing that color information for the pattern display data which represents the respective color and the “on/off” (“1”, “0”) information that represents the respective pixels. That data can be developed as data of a format capable of being directly input into the display controller. Also, that data can be developed as data of a format, too, wherein the respective one pixels of the color pattern are represented by the color numbers indicating that color. If that format is not the one capable of being directly input to the display controller, the data needs only to be converted by using a reference table such as a Look-Up Table (LUT). Since the LUT is the one used for reading out the output data by using the input data as an address, it enables the output data to be used for display without delay.

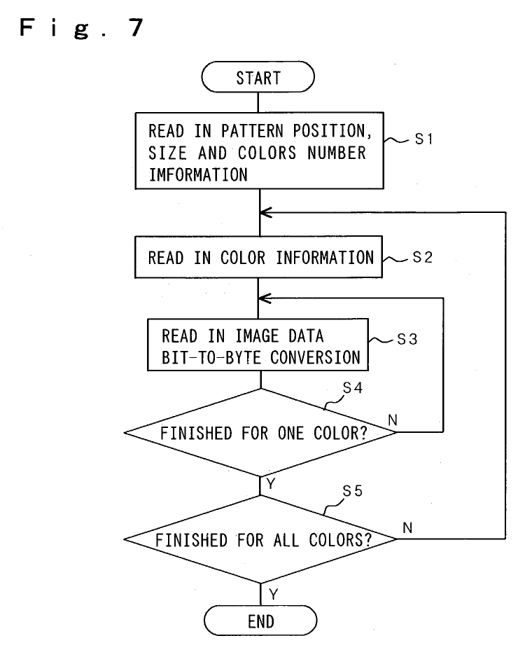

FIG. 6 is a conceptual view illustrating a method of processing a color pattern display data according to the present invention. The respective-color pattern display data previously stored into the ROM 3 in the above-described way is sequentially read out on a bit-by-bit basis. By the CPU 1, it is then converted into, for example, 1-byte-per-pixel data and is then developed onto the RAM 4. This conversion processing needs the time of a certain degree. However, since in the case of a pattern display the colors of which are small in number, the amount of data that is to be processed is small, the delay following the execution of the conversion processing does not become problematic very much. That data that has been developed is output to the LCD controller as is or by being converted using the LUT.

FIG. 7 is a flow chart illustrating an embodiment of the method of processing color pattern displayd at a according to the present invention. First, the CPU 1 reads in the information about the position, size, and colors number of a color pattern to be displayed according to the operator's operation, etc. (S1). Regarding those items of information, the ones that have been kept stored in the ROM 3 together with the pattern need only to be read in. It can also be arranged that they be read in by their format being changed according to the content of the operation, etc. This flow chart illustrates an example wherein only data that is initially read in has added thereto the position information and size information of the pattern and the remaining data has omitted therefrom the addition of that position information and size information. However, it can also be arranged, that the data has those items of information for every color and that data be read in every color.

Also, the information of the size needs only to be at least two items of data among the height, width, and pixels number of the relevant pattern. By those items of data, it is possible to cause a prescribed size of pattern to re-appear. The position and size information of the pattern becomes necessary not when rewriting the entire surface of the screen of the display device but when rewriting part of that screen or when additionally writing a new pattern, etc.

Next, the CPU 1 reads in the color information about a first color (S2) and subsequently reads in the image data about that color and performs bit-to-byte conversion (S3).

If that processing has finished being done about the first color (S4), regarding a second, a third, - - - color, the CPU 1 sequentially reads in the color information (S2) and reads in the image data and performs bit-to-byte conversion (S3) as in the case of the first color. When it has been determined (S5) according to the colors number information, that has been read-in in the step S1, that the processing about all colors has finished being executed, this process is terminated. The data that has been developed through the processing operations that have been performed as above is stored into the RAM 4 and is output to the display 5-2.

In the present invention, data formation regarding the respective color of the color pattern is performed, and it does not happen that the pattern fellows of the respective colors overlap one upon another. Therefore, by color-sequentially processing in the above-described way and writing data into the RAM only in regard to the portion where the relevant pattern exists, the display data corresponding to one screen wherein the respective color patterns are composed can be developed.

The color pattern display data stored in the ROM 3, even if it is not the format capable of being directly input to the display controller, is processed in the CPU 1 and, by being further converted using the LUT according to the necessity, made into data capable of being input to the display controller. Therefore, regarding the display controller, an existing one can be used. In addition, the data that has been developed into the RAM 4 can be read out with a high speed for being displayed.

Although the embodiment of the present invention has been explained as above, the present invention permits various modifications to be made. For instance, although the above-described embodiment is the one wherein the color pattern display data is stored into the ROM within the apparatus, it can be arranged, too, that that display data be stored into an external storage device and be read out for display.

Also, it can be arranged, too, that part of the pattern, having once been developed onto the RAM, be utilized when subsequent display is performed. Namely, when displaying a pattern that is only partially different from the immediately preceding display pattern, only in regard to that different portion the data is overwritten. And the pattern portion that is already developed and that can be utilized for the next display can be left as it is. Whether a pattern is the pattern that is only partially different from the immediately preceding display pattern can be determined according to the operation content instructing the pattern that is to be read out, the position and size, etc. of the pattern. In that case, since the CPU does not need to process the data regarding the entire screen of the display device, it is possible to decrease the amount of processing of the CPU.

Also, in a case where a pattern the pattern itself of which is the same and only the color of that is different continues, it can be arranged, too, that only new color information be read out and the color number of the display data already developed be directly changed. For instance, regarding “recording” and “reproduction” of a musical tone signal, in many cases, only the color is changed to “red” and “blue” in either case of which the signal status is displayed in the arrow pattern. In such a case, regarding the arrow pattern, there is no need to read out the relevant image data from the ROM and newly develop it. That is, it is sufficient that only the new color information be read out from the ROM and the display data be directly changed to the color number corresponding to that new color information. Saying in connection with the above-described example, if the pixel “0x08” is directly changed to “0x00”, it is possible to change the gray portion to a red portion.

The present invention is not limited to an electronic musical instrument but can be applied to various kinds of apparatuses arranged to selectively display a color pattern that is predetermined. Especially in a case where applied to each of the apparatuses arranged to display a color pattern the colors, used, number of which is small, the present invention provides a great effect of decreasing the storage capacity of data.

As apparent from the foregoing explanation, according to the present invention, it is possible to store color pattern display data as a smaller amount of data and to use it for display, thereby enabling decreasing the cost of the apparatus.

What is claimed is:

1. A method of storing color pattern display data, comprising:
a step of, regarding respective color of a color pattern, making the data thereof the one having a format of which one pixel consists of a 1 bit, and
a step of storing, together with those items of data, color information corresponding to the data.

2. A method of processing color pattern display data, comprising:
a step of sequentially reading out in units of a color, color pattern display data that is stored for every color of a relevant color pattern and that consists of data having a format of which one pixel consists of a 1 bit and color information corresponding to that data, and
a step of thereby making the color pattern display data the one having a format capable of being directly input to a display controller to thereby develop it into a RAM.

3. A method of processing color pattern display data, comprising:
a step of sequentially reading out in units of a color, color pattern display data that is stored for every color of a relevant color pattern and that consists of data having a format of which one pixel consists of a 1 bit and color information corresponding to that data, and
a step of thereby making the color pattern display data the one having a format wherein the respective one pixels of the color pattern are expressed by color numbers each indicating the color corresponding thereto, to thereby develop it into a RAM.

4. The method of processing color pattern display data according to claim 3, wherein, in a case where a color pattern to be displayed, or part thereof, is different only in color from the color pattern display data of which has immediately precedingly been developed, there are directly changed the color numbers representing the pixels of the relevant pattern in the color pattern display data that has immediately precedingly been developed.

5. The method of processing color pattern display data according to one of claim 2, wherein, in a case where a color pattern to be displayed is different only in part thereof from the color pattern display data of which has immediately precedingly been developed, the data and color information regarding that partial color pattern that is different are read out, and, according to the data and color information thereby obtained and the remaining-portion data that is already developed, the color pattern display data is developed into the RAM.

6. The method of processing color pattern display data according to one of claim 3, wherein, in a case where a color pattern to be displayed is different only in part thereof from the color pattern display data of which has immediately precedingly been developed, the data and color information regarding that partial color pattern that is different are read out, and, according to the data and color information thereby obtained and the remaining-portion data that is already developed, the color pattern display data is developed into the RAM.

7. The method of processing color pattern display data according to claim 2, wherein the color pattern display data is developed into the RAM in a format of which one pixel consists of one byte.

8. The method of processing color pattern display data according to claim 3, wherein the color pattern display data is developed into the RAM in a format of which one pixel consists of one byte.
